(19) United States
(12) Patent Application Publication
(10) Pub. No.: US 2010/0074378 A1
(43) Pub. Date: Mar. 25, 2010

(54) Method and System for Estimating a Signal and Computer Program Product

(75) Inventors: Po Shin Francois Chin, Singapore (SG); Yan Wu, Singapore (SG); Zhongding Lei, Singapore (SG); Sumei Sun, Singapore (SG)

Correspondence Address: CHOATE, HALL & STEWART LLP, TWO INTERNATIONAL PLACE, BOSTON, MA, 02110, US

(73) Assignee: c/o Agency for Science, Technology and Research, Connexix (SG)

(21) Appl. No.: 12/444,320

(22) PCT Filed: Oct. 5, 2007
(86) PCT No.: PCT/SG07/00339

§ 371 Date: Jun. 24, 2009

Related U.S. Application Data
(60) Provisional application No. 60/828,309, filed on Oct. 5, 2006.

(51) Int. Cl. H04L 27/06; H04B 1/10

(52) U.S. Cl. 375/341; 375/346

(57) ABSTRACT

A method for estimating a signal transmitted via a communication channel from a signal received via the communication channel, is described comprising carrying out a channel-dependent transformation of the received signal; and iteratively determining, channel-independently, an estimate for the transmitted signal on the basis of the transformed received signal.

### TECHNICAL FIELD

Embodiments of the invention generally relate to a method and a system for estimating a signal and a computer program product.

### BACKGROUND OF THE INVENTION

In mobile communications, high user capacities and high data rates are desirable. To achieve this, mobile radio systems have to be highly spectral efficient. Using multicarrier modulation according to OFDM (orthogonal frequency division multiplexing) robust performance and high spectral efficiency can be achieved.

Before the OFDM modulation, a pre-transform can be carried out, resulting in a so-called PT-OFDM (pre-transform OFDM) system. Iterative receivers can be used in such PT-OFDM systems. High performance can be achieved at the cost of low additional complexity with such receivers.

### SHORT DESCRIPTION OF THE FIGURES

FIG. 1 shows a transmitter/receiver system according to an embodiment of the invention.

FIG. 2 shows an estimation circuit.

FIG. 3 shows a flow diagram according to an embodiment of the invention.

FIG. 4 shows a receiver according to an embodiment of the invention.

FIG. 5 shows an estimation circuit according to an embodiment of the invention.

FIG. 6 shows an estimation circuit according to an embodiment of the invention.

FIG. 7 shows a decision circuit according to an embodiment of the invention.

FIG. 8 shows a decision circuit according to another embodiment of the invention.

FIG. 9 shows a decision circuit according to another embodiment of the invention.

FIG. 10 shows a decision circuit according to another embodiment of the invention.

FIG. 11 shows an estimation circuit according to an embodiment of the invention.

### DETAILED DESCRIPTION

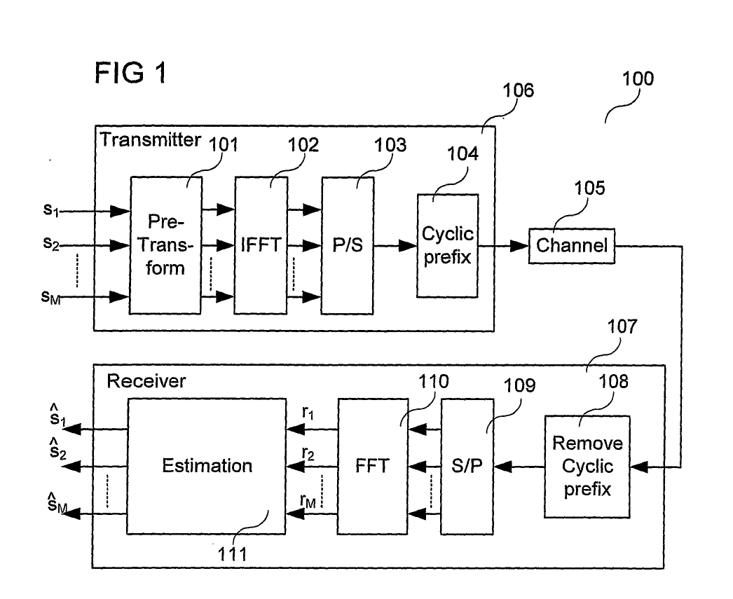

FIG. 1 shows a transmitter/receiver system 100 according to an embodiment of the invention.

The transmitter/receiver system 100 is formed according to a PT-OFDM (Pre-Transform Orthogonal Frequency Division Multiplexing) system. For simplicity, it is assumed that M=2^{k}, e.g. M=32, and that M information symbols sₘ, m=1, 2, . . . , M are transmitted at the same time in form of one OFDM symbol. For transmitting these information symbols, the vector of information symbols, s=[s₁, s₂, s_{M}]^{T}, in the following also called the original signal vector, is fed to a pre-transform circuit 101. The superscript T denotes the transpose operator.

The pre-transform circuit 101 calculates a vector of modulation symbols u=[u₁, u₂, u_{M}]^{T} for the original signal vector according to

u=W·s (1)

W represents a PT (pre-transform) matrix of size M×M. There is no loss of code rate in terms of number of information symbols transmitted per channel use. In the case of an OFDM system without pre-transform, the matrix W would simply be an identity matrix.

The vector (or block) of modulation symbols u generated by the pre-transform circuit 101 is then passed to an IFFT (inverse fast Fourier transform) circuit 102 which carries out an inverse fast Fourier transform on the block of modulation symbols.

The inverse fast Fourier transform is used in this example as an efficient realization of an inverse Fourier transform. Other domain transformations can be used instead of the inverse fast Fourier transform, for example an inverse discrete sine transform or an inverse discrete cosine transform.

The vector generated by the IFFT circuit 102 is then mapped from parallel to serial, i.e. to a sequence of signal values, by a P/S (parallel to serial) circuit 103. A cyclic prefix circuit 104 inserts a cyclic prefix into the sequence of signal values to form a PT-OFDM symbol which is transmitted via a communication channel 105.

The cyclic prefix that is inserted for example has a duration no shorter than the maximum channel delay spread. The channel 105 is for example a quasi/static frequency selective Rayleigh fading channel corrupted by additive white Gaussian noise (AWGN).

The pre-transform circuit 101, the IFFT circuit 102, the P/S circuit 103 and the cyclic prefix circuit 104 are part of a transmitter 106.

The PT-OFDM symbol is received by a receiver 107. A cyclic prefix removal circuit 108 removes the cyclic prefix from the PT-OFDM symbol. The resulting sequence of signal values is mapped from serial to parallel by a S/P circuit 109 and is domain transformed according to a fast Fourier transform by an FFT (fast Fourier transform) circuit 110. Analogously to the IFFT circuit 102, the FFT circuit 110 can in other embodiments also be adapted to perform a discrete sine transform or a discrete cosine transform or another domain transformation.

The output vector of the FFT circuit 110 is denoted by r=[r₁, r₂, . . . , r_{M}]^{T} and can be written as

r=Γ·s·n (2)

where Γ=diag(γ₁, γ₂, . . . , γ_{M}) is a diagonal matrix with diagonal elements γ₁, . . . , γ_{M} which are the frequency domain channel coefficients and n is the AWGN vector of dimension M×1.

The vector r is the received vector of information symbols. In other words, r is the part of the received signal corresponding to the part s of the transmitted signal.

The received vector of information symbols r is supplied to an estimation circuit 111 that generates an estimate ŝ for the transmitted vector s.

The estimation circuit 111 for example iteratively processes the received vector for the estimation of the transmitted vector.

An iteration (corresponding to an iteration index i) of the iterative estimation algorithm corresponds to three stages, a reconstruction step, a linear filtering step and a detection (or decision) step. Note that also the whole processing carried out by the estimation circuit 111 may be referred to as detection.

In the i-th reconstruction step, i.e. in the reconstruction step of the iteration corresponding to the iteration index i, the jth component of the received signal vector r is estimated, wherein j may be the same for different i. The jth component of the received signal vector r estimated in iteration i is denoted by rⱼ(i).

The component (for example a complex number) rⱼ(i) is for example estimated by using the result of the previous iteration (i−1) according to

rⱼ=γⱼwⱼ^{T}ŝ(i−1) (3)

wherein wⱼ^{T} denotes the jth row of W (written as column vector). The other components of r(i), i.e., the components of r(i) except for the jth component, are set to the components of r(i−1).

In the 0th iteration, where there is no r(i−1), r(0) is set to the received signal vector r for initialization.

In the i-th filtering step, the cross interference of the reconstructed signal vector according to the current iteration r(i) is removed by using a linear filter corresponding to the product of the matrix V=W⁻¹ and a filter matrix G(i). This means that the filter result ŝ (i) in the i-th iteration is given by

ŝ(i)=VG(i)r(i). (4)

The filtering may be done in two stages according to

y(i)=G(i)r(i)

ŝ(i)=vy(i). (5)

The matrix G(i) is a matrix for frequency domain equalization and is for example designed according to zero forcing or according to the MMSE (Minimum Mean Squared Error) criterion.

In the i-th decision step, the estimated signal vector of the i-th iteration is determined based on filter result (also called decision statistic) of the i-th iteration:

ŝ(i)=dec(ŝ(i)). (6)

In the decision step, a tentative (hard or soft) decision (denoted by dec(.)) is made to generate the symbol detected in the i-th iteration, ŝ(i).

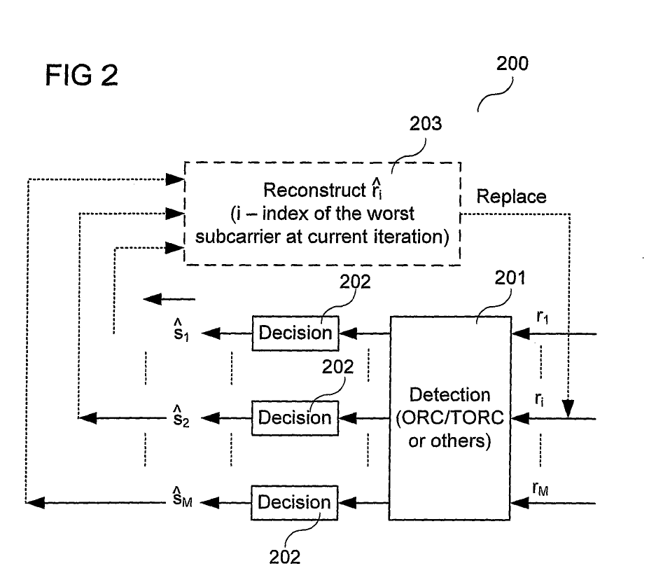

A possible structure of the estimation circuit 111 is illustrated in FIG. 2.

FIG. 2 shows an estimation circuit 200.

The estimation circuit includes a detection circuit 201, a plurality of decision circuits 202 and a reconstruction circuit 203.

In the 0th iteration, the detection circuit 201 is supplied with the received signal vector r. The components of the input to the detection circuit 201 r(i) (starting from r(0)=r) are one by one replaced in course of the iterative process by reconstructed components generated by the reconstruction circuit 203.

Based on the signal vector input to the detection circuit 201, the detection circuit generates a signal vector ŝ(i), for example by filtering as explained above, e.g. according to ORC (orthogonality restoring correlation) or according to TORC (threshold ORC).

Each component of ŝ(i) is fed to a decision circuit 202 which generates the corresponding component of the i-th estimation ŝ(i) of the transmitted signal vector s. The estimation ŝ(i) is fed to the reconstruction unit 203, which generates a reconstructed jth component of the received signal vector denoted by rⱼ(i) and replaces the jth component of the signal vector r(i) that is fed to the detection circuit 201 for the next iteration by rⱼ(i).

In the filtering step described above, the matrix G(i) or G (if it is the same for all iterations) depends on the properties of the communication channel 105. For example, G is determined based on the channel coefficients γ₁, . . . , y_{M}. In this case, the channel coefficients are needed during the iterative processing which may lead to high memory requirements.

Therefore, in one embodiment, a method is used in which in an iterative estimation process information about the characteristics of the communication channel 105 is not required.

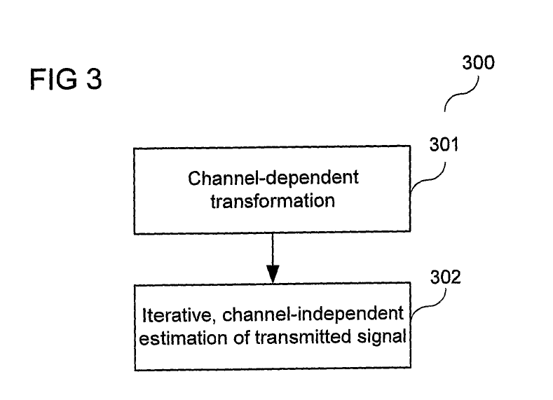

A method for estimating a signal transmitted via a communication channel from a signal received via the communication channel illustrated in FIG. 3.

FIG. 3 shows a flow diagram 300 according to an embodiment of the invention.

In 301, a channel-dependent transformation of the received signal is carried out.

In 302, an estimate for the transmitted signal is determined iteratively and channel-independently on the basis of the transformed received signal.

Illustratively, in one embodiment, the channel-dependency of the received signal is removed with a first channel dependent transformation, i.e. which depends on the transmission characteristics of the communication channel, such that afterwards, the estimation of the transmitted signal can be carried out channel-independently. Therefore, during the iterative determination process, information about the transmission characteristics of the communication channel are no longer needed. Low memory requirement and also low complexity of the iterative determination process can be achieved in this way.

In one embodiment, the channel-dependent transformation includes an equalization of the received signal. The equalization is for example a zero forcing (ZF) equalizer or Minimum Mean Square Error (MMSE) equalizer. For example, an initial value for the iterative determination of the estimate is generated from the equalized received signal.

The channel-dependent transformation may also include a timing correction, a phase error correction, and/or an intercarrier interference mitigation.

In one embodiment, in each iteration, an estimate for the transmitted signal is generated. For example, during each iteration, an estimated equalized received signal is generated according to the estimate for the transmitted signal of the current iteration.

In one embodiment, in each iteration, a decision statistic for the transmitted signal is generated and the estimate for the transmitted signal of the current iteration is generated based on the decision statistic. For example, the estimate for the transmitted signal of the current iteration is generated based on the decision statistic by a hard decision process or on a soft decision process. The estimate for the transmitted signal of the current iteration may also be generated, for example, using hard decision and forward error correction encoding, using soft decision and forward error correction encoding, or using soft input soft output decoding and soft input mapping.

The communication channel is for example a radio communication channel. The signal is for example transmitted using a plurality of sub-carriers, e.g. according to OFDM.

Signal values of the signal to be transmitted may be grouped into blocks, each block comprising a plurality of signal values and each signal value of a block may be transmitted using one sub-carrier. In one embodiment, for each block of the transmitted signal, a block of the estimated signal is generated.

The signal values of the received signal are for example grouped into a plurality of blocks corresponding to the blocks of the transmitted signal and the channel-dependent transformation of a received signal block for example corresponds to a multiplication of the received signal block with a matrix.

The channel-dependent transformation for example corresponds to the multiplication of a vector of values of the received signal with a matrix G.

The matrix G is for example
a frequency domain equalizer matrix;
the product of a timing correction matrix, which is a diagonal matrix with diagonal elements equal to exp(jkφ) wherein k=0, 1, . . . , M−1 and M is the dimension of the vector of received signal values and a frequency domain equalizer matrix;
the product of a common phase error correction matrix, which is a diagonal matrix with all diagonal elements equal to exp(jφ), and a frequency domain equalizer matrix;
the product of an ICI (intercarrier interference) mitigation matrix and a frequency domain equalizer matrix;
the product of a common phase error correction matrix, a timing correction matrix, and a frequency domain equalizer matrix;
the product of an ICI mitigation matrix, a timing correction matrix, and a frequency domain equalizer matrix.

The iterative determination is for example carried out block-wise to generate an estimated signal block for each block of the transmitted signal.

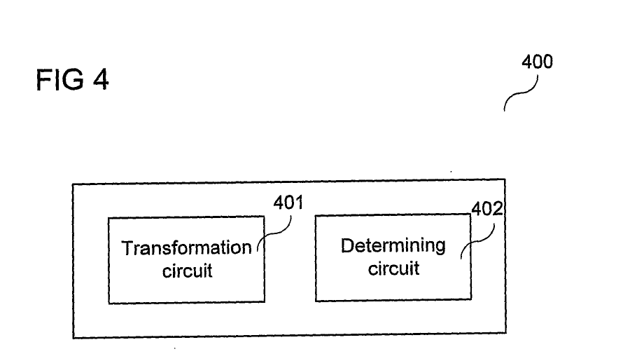

A receiver using the method illustrated in FIG. 3 is shown in FIG. 4.

FIG. 4 shows a receiver 400 according to an embodiment of the invention.

The receiver 400 includes a transformation circuit 401 configured to carry out a channel-dependent transformation of a signal received via a communication channel.

Further, the receiver 400 includes a determining circuit 402 that is configured to determine, channel-independently, an estimate for a transmitted signal received as the received signal on the basis of the transformed received signal.

A circuit can be a hardware circuit, e.g. an integrated circuit, designed for the respective functionality or also a programmable unit, such as a processor, programmed for the respective functionality. A processor may be for example be a RISC (reduced instruction set computer) processor or a CISC (complex instruction set computer).

A memory used in the embodiments of the invention may be a volatile memory, for example a DRAM (Dynamic Random Access Memory) or a non-volatile memory, for example a PROM (Programmable Read Only Memory), an EPROM (Erasable ROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

The receiver 400 is for example used in the transmitter/receiver system 100. This means that in one embodiment, the estimation circuit 111 includes a transformation circuit 401 and a determining circuit 402 as explained with reference to FIG. 4.

An example for the operation of such an estimation circuit is explained in the following.

In contrast to the iterative processing according to the equations (3), (4), and (6), the received signal vector r is not reconstructed in each step, but a reconstruction of the signal vector after frequency domain equalization y is generated. In the i-th iteration, the jth component of the reconstructed equalized signal vector y(i) is determined.

According to this embodiment, in the i-th iteration, the reconstruction step is carried out according to

yⱼ(i)=wⱼ^{T}ŝ(i−1). (7)

The filtering step is given by

ŝ(i)=Vy(i) (8)

and the detection step is as above given by

ŝ(i)=dec(ŝ(i)). (9)

For the 0th iteration, where there is no ŝ(i−1), y(0) is generated by a channel-dependent transformation from the received signal vector r, for example by a frequency domain equalization according to a frequency domain equalization matrix G which may be the same as the one used in equation (4).

In the case that the matrix G is generated using the channel coefficients γ₁, . . . , γ_{M}, the channel coefficients are only needed in the equalization step, but not during the iterative process. Memory usage may therefore be reduced compared to the iterative processing according to equations (3), (4), and (6).

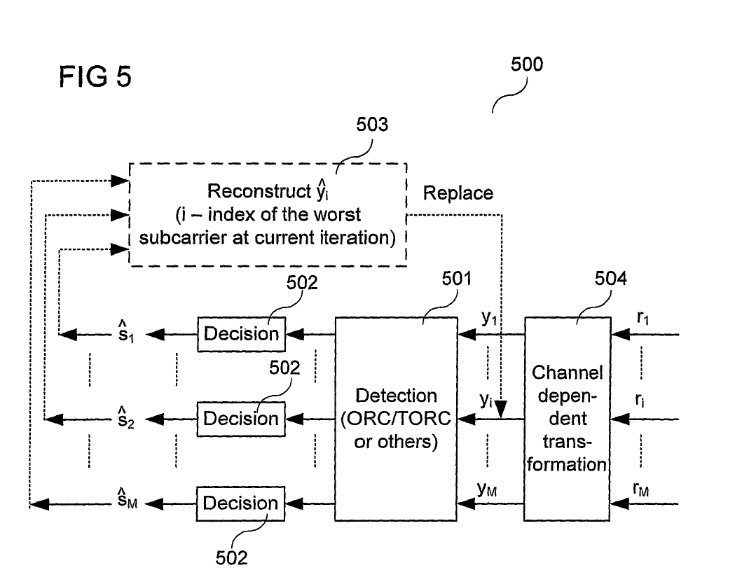

The processing according to equations (7), (8), and (9) is for example implemented by the estimation circuit 500 shown in FIG. 5.

FIG. 5 shows an estimation circuit 500 according to an embodiment of the invention.

The estimation circuit includes a detection circuit 501, a plurality of decision circuits 502, a reconstruction circuit 503, and an equalization circuit 504.

The received signal vector r is fed to the equalization circuit 504 (or in general a circuit carrying out a channel dependent transformation) which generates the starting value y(0) to be for the reconstructed equalized signal vector to be used in the 0th iteration. For example, y(0) is given by

y(0)=Gr (10)

In the 0th iteration, the output y(0) of the equalization circuit 504 is input into the detection circuit 501. The components of the input to the detection circuit 501 in the i-th iteration y(i) (starting from y(0)) are one by one replaced in course of the iterative process by equalized reconstructed components generated by the reconstruction circuit 503.

A component that was replaced in one iteration may be replaced in another iteration, i.e., a plurality of iterations may be used for reconstructing one component. Further, in one embodiment, multiple components are reconstructed parallely (e.g. by a version of the estimation circuit 500 that allows simultaneous reconstruction of more than one component) and are replaced together in the input to the detection circuit 501.

Based on the signal vector input to the detection circuit 501, the detection circuit generates a signal vector ŝ(i), for example by filtering according to equation (8) or according to ORC (orthogonality restoring correlation) or according to TORC (threshold ORC).

Each component of ŝ(i) is fed to a decision circuit 502 which generates the corresponding component of the i-th estimation ŝ(i) of the transmitted signal vector s. The estimation ŝ(i) is fed to the reconstruction unit 503, which generates the jth component of the equalized reconstructed vector denoted by yⱼ(i) and replaces the jth component of the signal vector y(i) that is fed to the detection circuit 501 for the next iteration by yⱼ(i). This means that y(i+1) is the same as y(i) except that the jth component of y(i+1) is yⱼ(i) (for all i=0, 1, . . . N, where N is the number of iterations).

A receiver design according to another embodiment of the invention is based on the following relationship between the decision statistic of the i-th iteration ŝ(i) and the decision statistic of the i-1-th iteration ŝ(i−1) which can be derived from equation (8):

ŝ(i+1)=ŝ(i)+(yⱼ(i+1)−yⱼ(i)vⱼ (11)

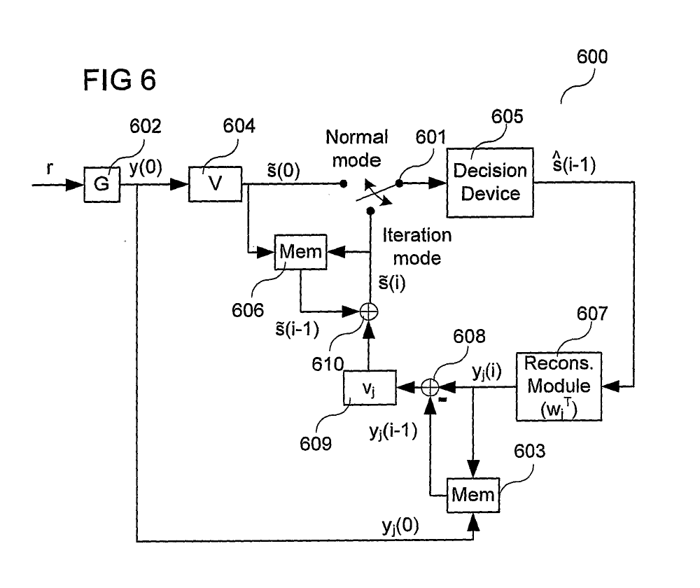

An estimation circuit based on this equation is illustrated in FIG. 6.

FIG. 6 shows an estimation circuit 600 according to an embodiment of the invention.

The estimation circuit 600 includes a switch 601 that has a setting for normal mode used for the 0th iteration and a setting for iteration mode used for the other iterations (i>0).

The estimation circuit 600 is supplied with the received signal vector r. The received signal vector r is filtered by a first filter 602 according to the matrix G (i.e. multiplied by G) to generate the vector y(0). The vector y(0) is stored in a first memory 603 and filtered by a second filter 604 according to the matrix V (i.e. multiplied by V) that generates the decision statistic ŝ(0) of the 0th iteration.

The decision statistic ŝ(0) is stored in a second memory 606 and, in normal mode, i.e. in the 0th iteration, the decision statistic ŝ(0) is fed to a decision circuit 605 which generates the estimated signal vector ŝ(0) of the 0th iteration. Generally, in the i-th iteration, the decision circuit 605 generates the estimated signal vector ŝ(i) of the i-th iteration. The output of the last (e.g. Nth) iteration is the output of the estimation circuit 600.

For the i-th iteration, the estimated signal vector ŝ(i−1) of the i-1-th iteration is fed to a reconstruction circuit 607 which generates the jth component of the equalized reconstructed signal vector yⱼ(i) by multiplication with wⱼ^{T} according to equation (7). The jth component of the equalized reconstructed signal vector yⱼ(i) is stored in the memory 603.

Further, yⱼ(i) is fed into a subtractor 608 which subtracts yⱼ(i−1) taken from the first memory 603 from yⱼ(i). Note that in this example, it is assumed that j does not change from iteration to iteration. In one embodiment, all components of yⱼ(i) are stored in the first memory 603 such that j may change from iteration to iteration. In one embodiment, the index j is fixed for all iterations but the iterative process is carried out for all sub-carriers for which an estimate should be determined. For example, the iterative process (iterations 0 to N) is carried out for subcarrier number 1, after that it is carried out for subcarrier number 2, and so on. The iterative processes for the different subcarriers may also be carried out in parallel, for example by a plurality of estimation circuits 600 as the one shown in FIG. 6.

The output of the subtractor 608 is filtered by a third filter 609 according to the jth column of the matrix V denoted by vⱼ (i.e. is multiplied by vⱼ). To the output of the third filter 609, the decision statistic ŝ(i−1) taken from the second memory 606 is added by an adder 610. The result of this addition is, according to equation (11), the decision statistic of the i-th iteration ŝ(i) which is stored in the second memory 606 for usage in the i+1th iteration and, in iteration mode, is fed to the decision circuit 605 which uses it to determine ŝ(i).

Illustratively, the estimation circuit 600 updates the decision statistic ŝ(i) from iteration to iteration. The update of the decision statistic only requires a multiplication of an M×1 vector and a scalar. Hence, a significantly reduced computation complexity can be achieved, compared, for example, with the iterative processing according to equations (3), (4), and (6) where a multiplication by the M×M matrix V with a M×1 vector has to be carried out in each iteration.

The decision statistic of the 0th iteration may be taken directly from an PT-OFDM detector.

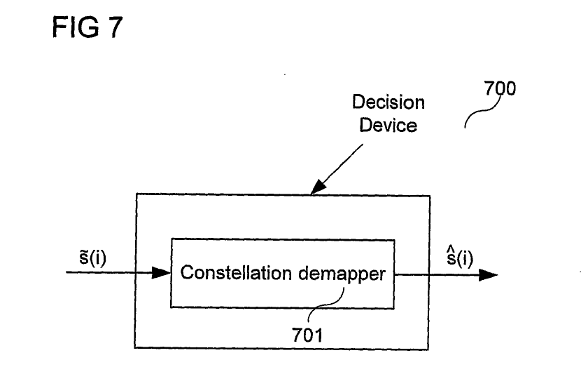

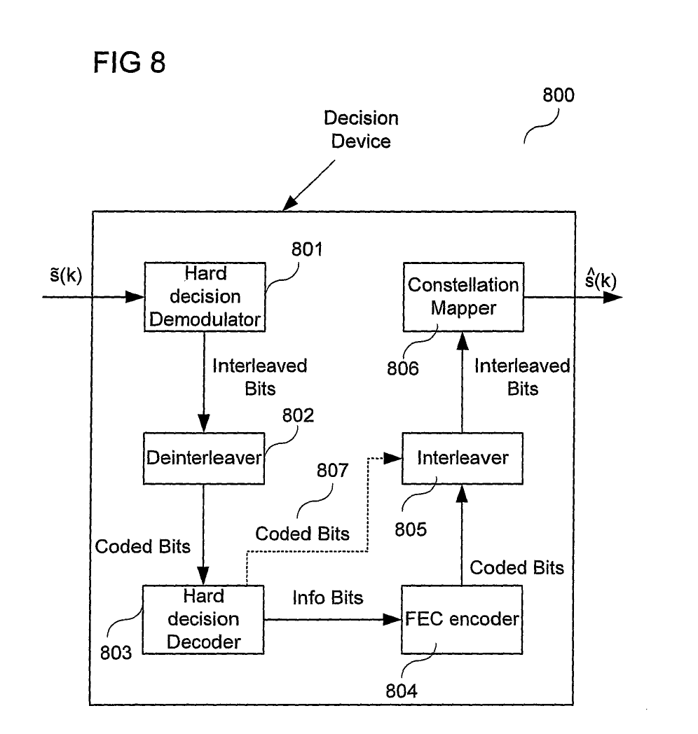

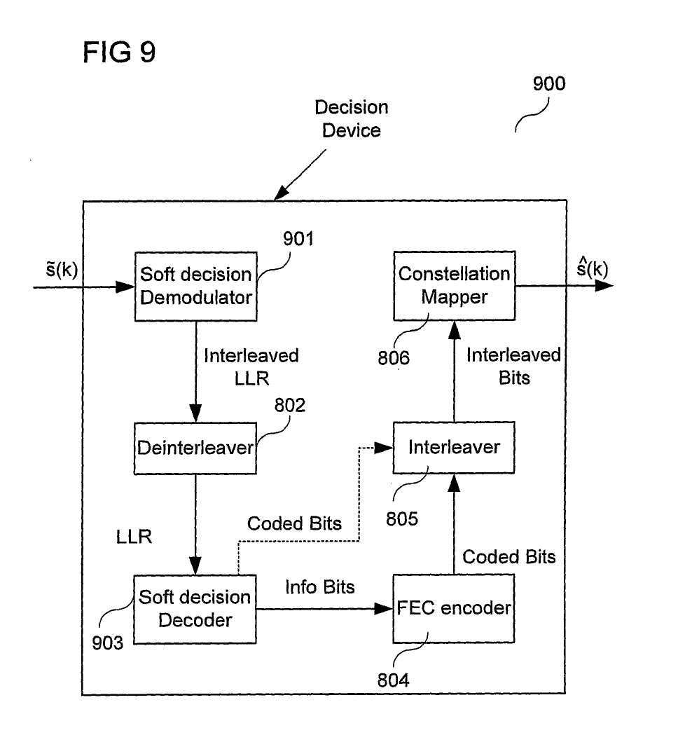

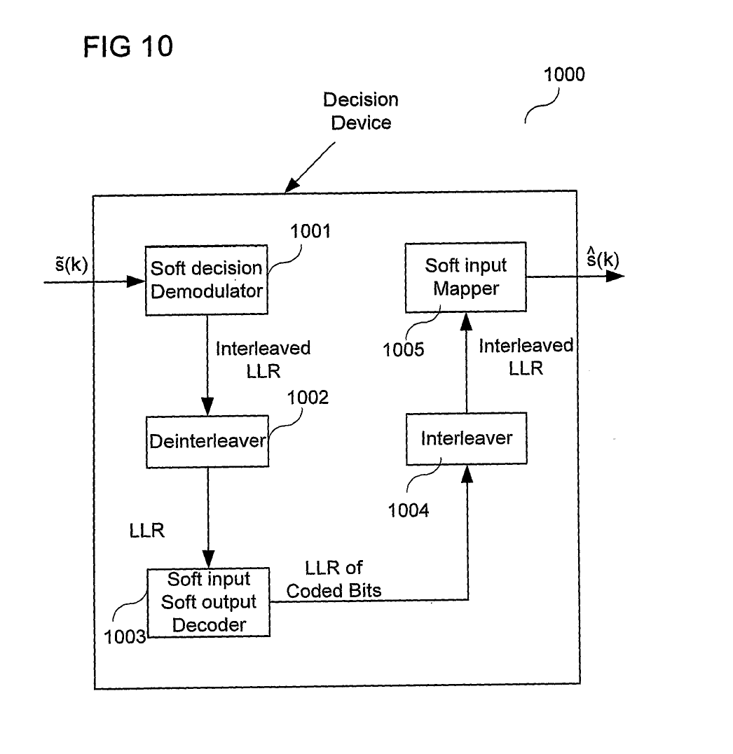

Possible implementations of the decision circuit 605 are illustrated in FIG. 7, FIG. 8, FIG. 9, and FIG. 10.

FIG. 7 shows a decision circuit 700 according to an embodiment of the invention.

The decision circuit 700 includes a constellation demapper that receives the decision statistic of the i-th iteration ŝ(i) as input and generates the demapped estimate of the transmitted signal vector of the i-th iteration ŝ(i).

FIG. 8 shows a decision circuit 800 according to another embodiment of the invention.

The decision circuit 800 receives the decision statistic of the i-th iteration ŝ(i) as input which is fed to a hard decision demodulation circuit 801. The output of the hard decision circuit 801 is de-interleaved by a de-interleaver 802. The output of the de-interleaver 802 is decoded by a hard decision decoder 803 to generate decoded bits. The decoded bits are re-encoded by an FEC (forward error correction) encoder 804 to generate re-encoded bits which are interleaved by an interleaver 805. A constellation mapper 806 generates the estimate of the transmitted signal vector of the i-th iteration ŝ(i) from the interleaved re-encoded bits. In one embodiment, the re-encoded bits are obtained from the decoded bits directly as indicated by the dotted line 807.

FIG. 9 shows a decision circuit 900 according to another embodiment of the invention.

The structure of the decision circuit 900 is similar to the structure of the decision circuit 800 shown in FIG. 8. However, it includes a soft decision demodulation circuit 901 and a soft decision decoder 903. The other components are the same as in the decision circuit 800.

FIG. 10 shows a decision circuit 1000 according to another embodiment of the invention.

The decision circuit 1000 receives the decision statistic of the i-th iteration ŝ(i) as input which is fed to a soft decision demodulation circuit 1001. The output of the hard decision circuit 1001 is de-interleaved by a de-interleaver 1002. The output of the de-interleaver 1002 is decoded by a soft input soft output decoder 1003 to generate statistics of the coded bits. The statistics of the coded bits are interleaved by an interleaver 1004. The interleaved statistics of the coded bits are fed to a soft input mapper 1005 which generates the estimate of the transmitted signal vector of the i-th iteration ŝ(i).

Note that in the above examples for decision circuits, it is assumed that the transmitter 106 includes a constellation mapper, i.e. the data to be transmitted is mapped to constellations.

A receiver design according to another embodiment of the invention is based on the relationship

$$\tilde{\underline{s}} ( i + 1 ) = \tilde{\underline{s}} ( i ) + {\underline{v}}_{j} ( {y}_{j} ( i + 1 ) - {y}_{j} ( i ) ) \\ = \tilde{\underline{s}} ( i ) + {\underline{v}}_{j} ( {\underline{w}}_{j}^{T} \underline{\hat{s}} ( i ) - {\underline{w}}_{j}^{T} \underline{\hat{s}} ( i - 1 ) ) \\ = \tilde{\underline{s}} ( i ) + {\underline{v}}_{j} {\underline{w}}_{j}^{T} ( \underline{\hat{s}} ( i ) - \underline{\hat{s}} ( i - 1 ) ) \\ = \tilde{\underline{s}} ( k ) + {\underline{v}}_{j} {\underline{w}}_{j}^{T} \underline{e} ( i ) \qquad ( 12 )$$

wherein

e(i)=ŝ(i)−ŝ(i−1). (13)

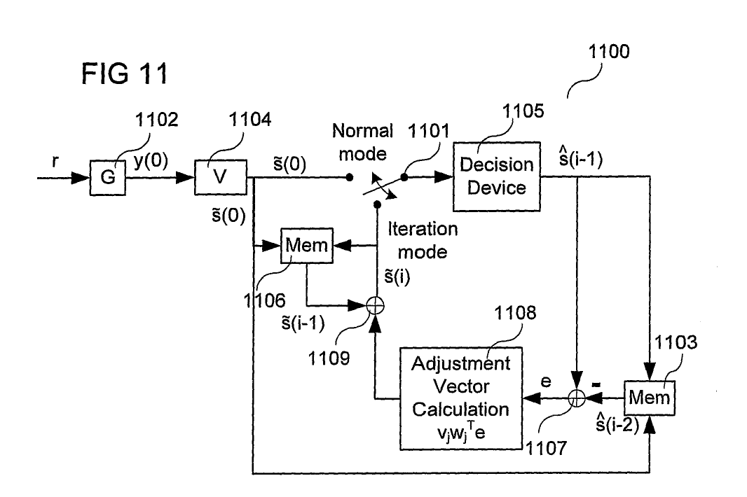

An estimation circuit based on this equation is illustrated in FIG. 11.

FIG. 11 shows an estimation circuit 1100 according to an embodiment of the invention.

The estimation circuit 1100 includes a switch 1101 that has a setting for normal mode used for the 0th iteration and a setting for iteration mode used for the other iterations.

The estimation circuit 1101 is supplied with the received signal vector r. The received signal vector r is filtered by a first filter 1102 according to the matrix G (i.e. is multiplied by G) to generate the vector y(0). The vector y(0) is filtered by a second filter 1104 according to the matrix V (i.e. multiplied by V) that generates the decision statistic ŝ(0) of the 0th iteration.

The decision statistic ŝ(0) is stored in a first memory 1106 and, in normal mode, i.e. in the 0th iteration, the decision statistic ŝ(0) is fed to a decision circuit 1105 which generates the estimated signal vector ŝ(0) of the 0th iteration. Generally, in the i-th iteration, the decision circuit 1105 generates the estimated signal vector ŝ(i) of the i-th iteration. The output of the last (e.g. Nth) iteration is the output of the estimation circuit 1100.

The estimated signal vector ŝ(i−1) of the i−1-th iteration is stored in a second memory 1103 and is fed, for the i-th iteration, to a subtractor 1107 which subtracts the estimated signal vector of the previous iteration ŝ(i−2) taken from the second memory 1103 from ŝ(i−1) and supplies the result, which is equal to e(i) according to equation (13), to a multiplier 1108 multiplying e(i) with vⱼwⱼ^{T}.

To the output of the multiplier 1108, the decision statistic ŝ(i−1) taken from the first memory 1106 is added by an adder 1109. The result of this addition is, according to equation (12), the decision statistic of the i-th iteration ŝ(i) which is stored in the first memory 1106 for usage in the i+1th iteration and, in iteration mode, is fed to the decision circuit 1105 which uses it to determine ŝ(i).

Similar to the estimation circuit 600 described with reference to FIG. 6, in one embodiment, the index j is fixed for all iterations but the iterative process is carried out for all sub-carriers for which an estimate should be determined. For example, the iterative process (iterations 1 to N) is carried out for subcarrier number 1, after that it is carried out for subcarrier number 2, and so on. The iterative processes for the different subcarriers may also be carried out in parallel, for example by a plurality of estimation circuits 1100 as the one shown in FIG. 11.

Note that mathematically, the processing carried out by the estimation circuit 500, the estimation circuit 600, and the estimation circuit 1100 is equivalent to the processing carried out by the estimation circuit 200.

The decision circuit 1105 may be for example implemented according to the examples described with reference to FIGS. 7 to 10.

According to one embodiment of the invention a method for detecting a signal received via a communication channel, the communication channel being affected by noise, is provided, including:
equalizing the received signal by a channel dependent frequency domain equalizer;
filtering the equalized signal in accordance to a orthogonal matrix;
decision processing the filtered signal using a plurality of decision modules to form decision signal; wherein the decision processing is a step of soft decision processing, or a step of hard decision processing;
refining the decision signal a number of times from the previous decision signal.

The said number of times of refining is for example a predetermined number or dependent on the difference of two consecutive refined signals.

In one embodiment of the invention, the refining step further includes
reconstructing at least one component of the equalized signal by multiplying the decision signal with corresponding vectors in another orthogonal matrix;
re-estimating the corresponding component in the said filtered signal by multiplying the reconstructed components of the equalized signal with a corresponding vectors in said orthogonal matrix;
updating said filtered signal with the re-estimated corresponding component in the said filtered signal; and
determining the new decision signal from the updated signal using said plurality of decision modules; wherein the decision processing is a step of soft decision processing, or a step of hard decision processing.

According to one embodiment, the refining step further includes
reconstructing at least one component of the equalized signal by multiplying the decision signal with corresponding vectors in another orthogonal matrix;
re-estimating the corresponding component in the said filtered signal by multiplying the reconstructed components of the equalized signal with a corresponding vectors in said orthogonal matrix, or by multiplying the difference of reconstructed components of the equalized signal, over two consecutive rounds, with a corresponding vectors in said orthogonal matrix;
updating said filtered signal with the re-estimated corresponding incremental component in the said filtered signal; and
determining the new decision signal from the updated signal using said plurality of decision modules; wherein the decision processing is a step of soft decision processing, or a step of hard decision processing.

According to another embodiment of the invention, the refining step further includes
reconstructing at least one component of the incremental equalized signal by multiplying the difference of the decision signal, over two consecutive rounds, with a corresponding vectors in another orthogonal matrix;
re-estimating the corresponding component in the said filtered signal by multiplying the reconstructed components of the incremental equalized signal with a corresponding vectors in said orthogonal matrix with a corresponding vectors in said orthogonal matrix;
updating said filtered signal with the re-estimated corresponding component in the said filtered signal; and
determining the new decision signal from the updated signal using said plurality of decision modules; wherein the decision processing is a step of soft decision processing, or a step of hard decision processing

The equalizing step for example includes multiplication of at least one component of the received signal with a equalizer coefficient and the equalizer coefficient for example includes a noise variance offset which corresponds to the variance of the noise affecting the communication channel.

According to one embodiment of the invention, a detector according to the method for detecting a signal described above is provided.

The channel dependent frequency domain equalizer is for example a zero forcing (ZF) equalizer or Minimum Mean Square Error (MMSE) equalizer.

1. A method for estimating a signal transmitted via a communication channel from a signal received via the communication channel, comprising
carrying out a channel-dependent transformation of the received signal; and
iteratively determining, channel-independently, an estimate for the transmitted signal on the basis of the transformed received signal.

2. The method according to claim 1, wherein the channel-dependent transformation includes an equalization of the received signal.

3. The method according to claim 2, wherein the equalization is for example a zero forcing equalizer or Minimum Mean Square Error equalizer.

4. The method according to claim 1, wherein the channel-dependent transformation includes a timing correction.

5. The method according to claim 1, wherein the channel-dependent transformation includes a phase error correction.

6. The method according to claim 1, wherein the channel-dependent transformation includes an intercarrier interference mitigation.

7. The method according to claim 2, wherein from the equalized received signal an initial value for the iterative determination of the estimate is generated.

8. The method according to claim 1, wherein, in each iteration, an estimate for the transmitted signal is generated.

9. The method according to claim 8, wherein, during each iteration, an estimated equalized received signal is generated according to the estimate for the transmitted signal of the current iteration.

10. The method according to claim 9, wherein, in each iteration, a decision statistic for the transmitted signal is generated and the estimate for the transmitted signal of the current iteration is generated based on the decision statistic.

11. The method according to claim 10, wherein the estimate for the transmitted signal of the current iteration is generated based on the decision statistic by a hard decision process or a soft decision process.

12. The method according to claim 10, wherein the estimate for the transmitted signal of the current iteration is generated using hard decision and forward error correction encoding.

13. The method according to claim 10, wherein the estimate for the transmitted signal of the current iteration is generated using soft decision and forward error correction encoding.

14. The method according to claim 10, wherein the estimate for the transmitted signal of the current iteration is generated using soft input soft output decoding and soft input mapping.

15. The method according to claim 1, the communication channel being a radio communication channel.

16. The method according to claim 1, the signal being transmitted using a plurality of sub-carriers.

17. The method according to claim 16, signal values of the signal to be transmitted being grouped into blocks, each block comprising a plurality of signal values and each signal value of a block being transmitted using one sub-carrier.

18. The method according to claim 17, wherein for each block of the transmitted signal, a block of the estimated signal is generated.

19. The method according to claim 18, wherein the signal values of the received signal are grouped into a plurality of blocks corresponding to the blocks of the transmitted signal and the channel-dependent transformation of a received signal block corresponds to a multiplication of the received signal block with a matrix.

20. The method according to claim 19, wherein the iterative determination is carried out block-wise to generate an estimated signal block for each block of the transmitted signal.

21. A system for estimating a signal transmitted via a communication channel from a signal received via the communication channel, comprising
a transformation circuit configured to carry out a channel-dependent transformation of the received signal; and
a determining circuit configured to iteratively determine, channel-independently, an estimate for the transmitted signal on the basis of the transformed received signal.

22. A computer program product, which, when executed by a computer, makes the computer perform a method for estimating a signal transmitted via a communication channel from a signal received via the communication channel, comprising
carrying out a channel-dependent transformation of the received signal; and
iteratively determining, channel-independently, an estimate for the transmitted signal on the basis of the transformed received signal.
